(19) United States
(12) Patent Application Publication
(10) Pub. No.: US 2008/0126600 A1
(43) Pub. Date: May 29, 2008

(54) Direct memory access device and methods

(75) Inventors: John D. Mitchell, Bloomington, IN (US); Joseph C. Circello, Phoenix, AZ (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: Freescale Semiconductor, Inc., Austin, TX (US)

(21) Appl. No.: 11/513,639

(22) Filed: Aug. 31, 2006

(51) Int. Cl. G06F 13/28

(52) U.S. Cl. 710/22

(57) ABSTRACT

A method and device for processing direct memory access transfer requests is disclosed. The method includes executing a first transfer request associated with a channel of a DMA device, and determining if the next transfer request is associated with the same channel. If the next transfer request is associated with a different channel, the DMA device executes an arbitration process to determine the priority of the second transfer request relative to other pending transfer requests. If the next transfer request is associated with the same channel as the first transfer request, the DMA device executes the next transfer request without executing the normal arbitration process. By foregoing execution of the arbitration process when two transfer requests are associated with the same channel, the DMA device is able to begin execution of the transfer requests more quickly.

### FIELD OF THE DISCLOSURE

The present disclosure is related to devices supporting direct memory accesses and more particularly to devices and their methods of supporting data transfers as a direct memory access device.

### BACKGROUND

Typical data processing devices often use a technique known as a direct memory access (DMA). Using direct memory access, information can be directly transferred between locations in the data processing device, such as between peripheral modules and a memory with only minimal involvement by a module requesting the information transfer, such as a central processing unit (CPU), once the information transfer is initiated. Thus a DMA device functions to transfer data from a source, such as memory, in a data processing system to a destination, such as a peripheral module. The DMA device can receive multiple pending transfer requests from one or more requesting modules, and uses an arbitration scheme to determine the order of execution of the pending requests.

Further, a transfer request can be linked to another transfer request. For example, a destination module may need two sets of information from a memory, such as payload and control information, to execute a desired function. Accordingly, the transfer request for the payload data can link to the transfer request for the command data to indicate to the arbiter that the linked transfer request should be prioritized. However, a faster method of executing linked requests would be desirable.

Accordingly, it will be appreciated that an improved DMA device would be advantageous.

### BRIEF DESCRIPTION OF THE DRAWINGS

FIG. 1 is a block diagram of a particular embodiment of a data processing device incorporating a DMA device in accordance with the present disclosure;

FIG. 2 is a timing diagram illustrating a particular relationship of between two methods of executing sets of transfer requests at the DMA device of FIG. 1;

FIG. 3 is a block diagram illustrating a particular embodiment of the DMA device of FIG. 1; and

FIG. 4 is a flow diagram illustrating a particular embodiment of a method of processing a transfer request at a DMA device in accordance with the present disclosure.

### DETAILED DESCRIPTION

A method and device for processing direct memory access transfer requests is disclosed. The method includes executing a first transfer request associated with a channel of a DMA device, and determining if the next transfer request is associated with the same channel. If the next transfer request is associated with a different channel, the DMA device executes an arbitration process to determine the priority of the second transfer request relative to other pending transfer requests. If the next transfer request is associated with the same channel as the first transfer request, the DMA device executes the next transfer request without executing the normal arbitration process. By foregoing execution of the arbitration process when two transfer requests are associated with the same channel, the DMA device is able to begin execution of the linked transfer request more quickly.

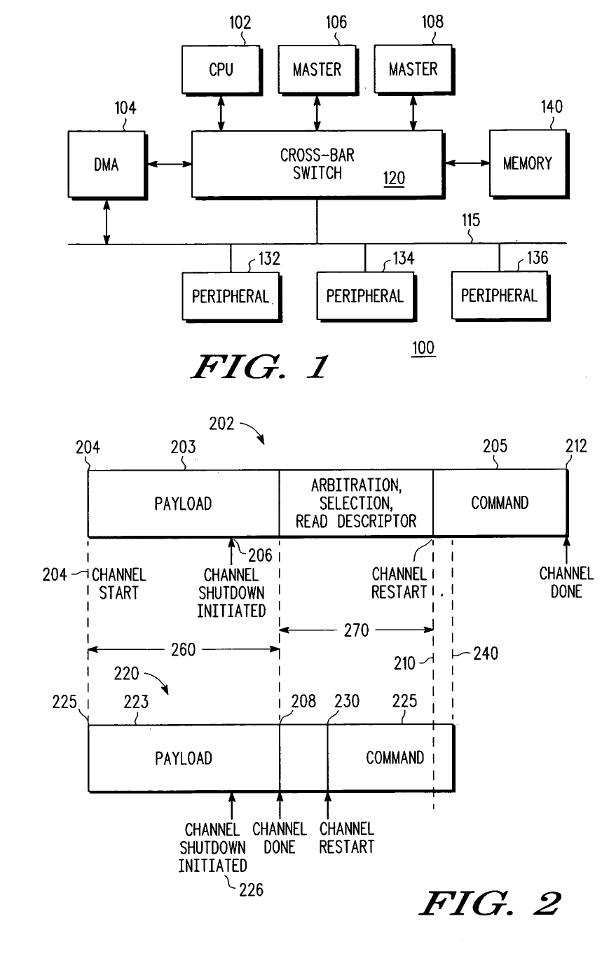

Referring to FIG. 1, a block diagram of a particular embodiment of a data processing device 100 is illustrated. The data processing device 100 includes master devices including a central processing unit (CPU) 102, a direct memory access (DMA) device 104, master devices 106 and 108, and slave devices including a peripheral bus 115 and a memory 140, each connected to cross-bar switch 120. The DMA device is also connected to a peripheral bus 115. For this discussion, a bus master device is capable of initiating data transfers and bus slave devices are simply responders to transfers initiated by the masters. The master devices 106 may be additional data processing devices, additional DMA devices, and the like. The device 100 also includes peripheral modules 132, 134, and 136, each connected to the peripheral bus 115. The peripheral modules 132, 134, and 136 can be communication interfaces, graphics controllers, network controllers, storage devices, and the like.

During operation, DMA device 104 receives transfer requests through hardware via hardwired peripheral request signals or through software executed at the CPU 102 or other module. The transfer requests may be received from one of the peripheral modules 132, 134, and 136, from the CPU 102, or from one of the master devices 106 and 108. For purposes of discussion it is assumed that the transfer request is received from the peripheral module 132. The transfer requests indicate a source and a destination for a data transfer. The source and destination can be any of the peripheral devices and slave modules connected to the cross-bar switch 140. Further, the source and destination can be different from the device or module that sends the transfer request. For example, the CPU 102 can send a transfer request to the DMA 104 to transfer data from the memory 140 to the peripheral module 132.

Each slave module or slave devices connected to the cross-bar switch 120 can be associated with one or more channels of the DMA device 104. To execute a transfer request, the DMA device 104 accesses the source to retrieve the requested information and provides the data to the destination via the associated DMA channel. In a particular embodiment, data is transferred from the source to the destination iteratively, with a portion of the data transferred at each iteration followed by adjusting the source and destination addresses. Transfer of the data in this iterative fashion allows for data to be transferred flexibly. For example, ten 1 kilobyte portions of the transferred data can be transferred to ten non-sequential memory locations at 1 Megabyte offsets, or sequentially to 10 kilobytes of memory. The iterative transfers for an entire transfer request is together referred to as the major loop of the transfer request. Each major loop can include a number of minor loops, with each minor loop including one or more iterative transfers. For purposes of discussion, the term transfer request herein refers to a major loop transfer.

To initiate a transfer, a source sends a transfer service request to the DMA device 104. The transfer service request is initiated through hardware via hardwired peripheral request signals or through software via writing to a register or other storage location at the DMA device 104. The transfer service request indicates a channel of the DMA device 104 for the associated transfer. The DMA device 104 stores a transfer descriptor for each channel to describe different characteristics of the transfer request, including the destination device or address associated with the request, the source device or address, the number of minor loops in the data transfer, the address offsets associated with each minor loop, and other information.

In addition, the DMA device 104 can operate in a channel link mode. If the channel link mode is enabled, a first transfer descriptor can indicate the channel associated with a second transfer descriptor pending at the DMA device 104. The second transfer descriptor is thus linked to the first transfer descriptor. This allows the DMA device 104 to set up the channel associated with the linked transfer descriptor while the first transfer request is being executed. Channel linking can be useful in a variety of situations. For example, the DMA device 104 can execute linked transfer descriptors to send from a common device both payload data to be communicated and control information to control the parameters of communication.

In response to determining that a first transfer request is linked with a second transfer request, and that both transfer requests are associated with a single channel, the DMA device 104 executes the second transfer request after the first, without executing the arbitration process for the second transfer request. Accordingly, the second transfer request is executed atomically with respect to the arbitration process. This allows the DMA device 104 to execute linked transfer requests for the same channel rapidly, and reduces the latency between receiving and responding to the linked requests. In addition, because arbitration and execution of a transfer request can require some minimal intervention by the CPU or other requesting device, executing linked transfer requests without arbitration of the second request can reduce undesirable intervention by the requesting device.

In the event that linked requests are associated with different channels, the DMA device 104 executes an arbitration process for the pending transfer descriptors to determine the order in which the transfer requests will be executed, so that the arbitration process is executed upon completion of each transfer request to determine the next transfer request that will be processed. Different arbitration schemes may be applied by the DMA device 104, including a round-robin arbitration scheme, a channel priority ranking arbitration scheme, and the like.

Referring to FIG. 2, a diagram illustrating execution of two sets of linked transfer requests is illustrated. The first set of linked transfer requests 202 includes a first transfer request 203 and a second transfer request 205. The second transfer request 205 is linked to the first transfer request 203. In a particular embodiment, the transfer descriptor associated with the first transfer request 215 includes a field indicating that it is linked to the second transfer request 203 and a field indicating the DMA channel associated with the second request. In the illustrated embodiment, the first transfer request 203 is associated with a first channel while the second transfer request is associated with a second channel different from the first.

During operation, the DMA device 104 executes the first transfer request 203 during a first time interval 260, between a time 204 and a time 208. During the first time interval 260, the data associated with the first transfer request is transferred from the memory 140 to the peripheral module associated with the channel of the first transfer request 203. In addition, at time 206, a channel shutdown operation is initiated. During the channel shutdown process, the DMA device 104 performs a number of operations, such as updating counters, updating source and destination information for a transfer descriptor, evaluating optional interrupt requests, and the like.

In addition, during the channel shutdown process the DMA device 104 can perform a scatter/gather operation by retrieving a new transfer descriptor. During the channel shutdown operation, the DMA device 104 analyzes the pending transfer descriptor associated with the first transfer request 203 to determine that it is linked to the second transfer request 205, and that the second transfer request 205 is associated with a different channel.

Accordingly, during a second time interval 270, between time 208 and 210, the DMA device 104 executes an arbitration operation on the second transfer request 205, to determine the priority of the transfer request relative to additional transfer requests pending at the DMA device 104. In addition, once the arbitration operation is complete, the DMA device 104 reads the transfer descriptor associated with the transfer request selected by the arbitration process.

In the illustrated example of the first set of linked transfer requests 202, the arbitration process selects the second transfer request 205 and the DMA device 104 executes the transfer request during a third time interval, between a time 210 and a time 212. It will be appreciated that the arbitration process could select other transfer requests prior to executing the second transfer request 205, thereby extending the time used to execute the first set of linked transfer requests 202.

The second set of linked transfer requests 220 include a first transfer request 223 and a second transfer request 225, each of which are associated with the same channel of the DMA device 104. The first transfer request 223 is executed during the first time interval 260. At time 226, the DMA device 104 executes the channel shutdown operation for the transfer request 223 and determines that the transfer request is linked to the transfer request 225, and that the transfer request 225 is associated with the same channel. Accordingly, the DMA device 104 closes the channel at time 208, but reopens the channel at time 230, without executing the arbitration process for the transfer request 225. Thus, the transfer request 225 is executed during the second time interval 270, and the amount of time required to execute the second set of transfer requests 220 is reduced.

In addition, the transfer request 225 may be linked to a third transfer request (not shown). If the third transfer request is associated with the same channel, the DMA device 104 can execute the third transfer request without arbitrating the request. Accordingly, the DMA device 104 can execute a series of linked transfer requests without arbitrating the requests, thereby reducing the amount of time required to execute the series of requests and improving the efficiency of the DMA device 104.

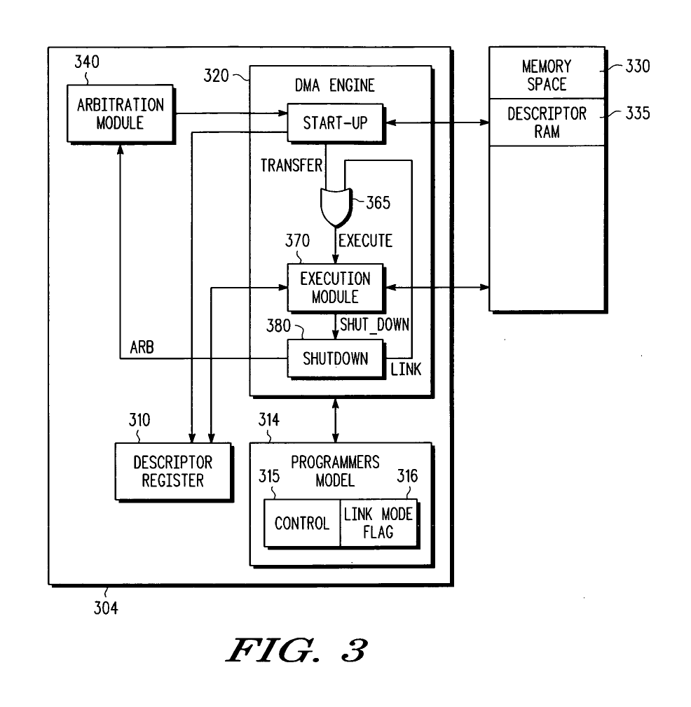

Referring to FIG. 3, a block diagram of a particular embodiment of a DMA device 304, corresponding to the DMA device 104, is illustrated. The DMA device 304 includes a DMA engine 320 connected to access a control register 315 of the programmer's model 314, a descriptor register 310 which may be within the programmer's model 314, an arbitration module 340, and a memory space 330. The memory space 330 includes addressable locations of the device 100, including peripheral input/output locations, and memory including descriptor RAM 335, which stores transfer descriptors for the channels of the DMA device 104. The control register 315 includes a “continuous link” mode flag 316 to enable a continuous channel link mode for the DMA device 304. In a particular embodiment, the transfer descriptors stored in the descriptor RAM 335 can include additional link mode bits to selectively enable or disable a channel link mode for each channel of the DMA device 304.

The DMA engine 320 includes a start up module 360 including an input connected to the arbitration module 340, a connection to the descriptor RAM 335, an output connected to the descriptor register 310, and a control output to provide a signal TRANSFER. The DMA engine also includes an OR gate 365 including an input to receive the signal TRANSFER, a second input to receive a signal LINK, and an output to provide a signal EXECUTE. The DMA engine further includes an execution module 370 including an input to receive the signal EXECUTE, a connection to the descriptor register 310, a connection to the memory space 330, and an output to provide the signal SHUT_DOWN. The DMA engine 320 also includes a shutdown module 380 including an input to receive the signal SHUT_DOWN, an output to provide a signal ARB and an output to provide a signal LINK.

During operation, the DMA device 304 may execute transfer requests by accessing the transfer descriptors stored at the RAM 330. The arbitration module 340 arbitrates pending transfer requests, and indicates to the start-up module 360 which channel has priority. The start-up module 360 loads the descriptor associated with the selected channel from descriptor RAM 335 to descriptor register 310, and asserts the signal TRANSFER, causing the OR gate 365 to assert the signal EXECUTE. In response, the execution module 370 executes the transfer request based on the contents of the descriptor register 310. During execution, the execution module 370 modifies the contents of the descriptor register 310 to change the source address, destination address, or other parameters. Once the transfer has been executed, the execution module 370 asserts the signal SHUT_DOWN to indicate to the shutdown module 380 that channel shutdown can begin. It will be appreciated that shutdown can occur in accordance with the present disclosure in response to completion of a minor loop or major loop at the DMA engine 320.

If the continuous link mode bit 316 indicates that a continuous link mode is enabled for the DMA device 304, shutdown module 380 consults the descriptor register 310 to determine if the current transfer descriptor is linked to a second transfer descriptor stored at the descriptor RAM 335 or linked to the current transfer descriptor located in the descriptor register 310. If a link to the same channel is determined to exist, shutdown module 380 asserts the signal LINK and leaves the signal ARB deasserted. In response to assertion of the signal LINK, the OR gate asserts the signal EXECUTE, and the execution module 370 executes the current descriptor without performing an arbitration process.

If the target link channel is associated with a different channel, or if the channel link mode is not enabled, shutdown module 380 asserts the ARB signal and leaves the LINK signal deasserted, so that the arbitration module 340 determines and notifies the start-up module which channel is to be serviced next. Note that when linking to a channel other than the current channel is requested, an indication of the linked channel is provided to the arbitration module for consideration.

In accordance with one embodiment, the arbitration module 340 executes an arbitration process according to a particular arbitration scheme to determine which of the stored transfer requests should be executed next, and indicates the channel associated with the selected transfer request to the startup module 360. In this manner, when linking is enabled, and the DMA engine is linking to the current channel the latency associated with the arbitration module 340 and startup module 360 can be avoided.

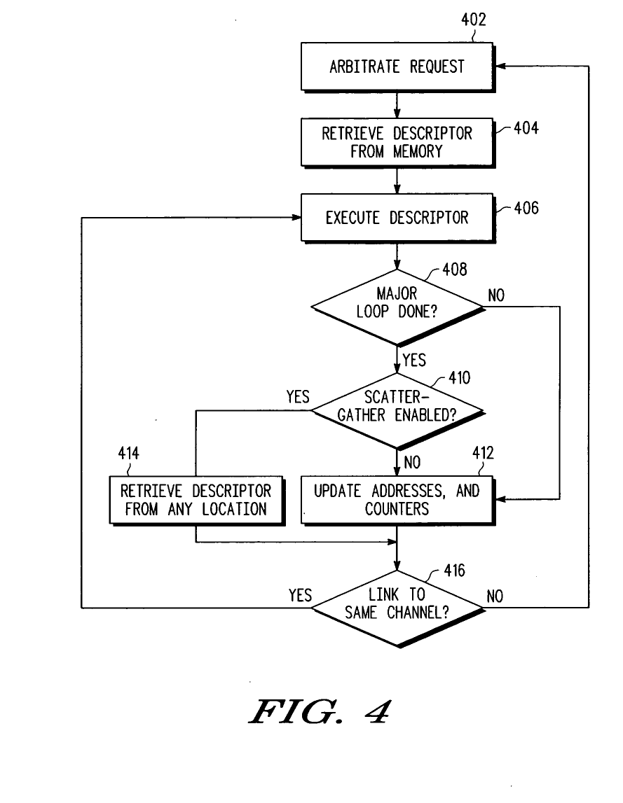

Referring to FIG. 4, a flow chart of a particular embodiment of a method of executing a transfer request at a DMA device is illustrated. At block 402, the DMA device arbitrates a set of pending transfer requests to select a transfer request for execution. The method flow moves to block 404 and the transfer descriptor for the channel of the selected transfer request is retrieved from RAM and loaded into a descriptor register. The method flow then moves to block 406 and the DMA device executes the transfer descriptor by transferring data from the source identified by the descriptor to the identified destination.

The method flow moves to decision block 408, and the DMA device determines whether a major loop of the DMA device is complete. In a particular embodiment, the DMA device consults a counter field of the transfer descriptor in the descriptor register to determine if the major loop is complete. If the major loop is not complete the method flow moves to block 412 and the DMA device updates the counter field as well as the source and destination address for the descriptor in the descriptor register. This allows the DMA device to alter the source and destination addresses for subsequent transfers at the DMA channel associated with the transfer descriptor, thereby permitting flexible transfers of data through iterations of the major loop.

After the addresses and counter field of the transfer descriptor have been updated, the method flow moves to block 416, and the DMA device determines if the transfer descriptor in the descriptor register indicates a link to the same DMA channel that is associated with the transfer descriptor. If so, the method flow returns to block 406, and the modified transfer descriptor in the descriptor register is executed without performing an arbitration process or retrieving the descriptor from memory. Accordingly, the DMA device can perform repeated transfers at the same channel without arbitrating each transfer, thereby improving the efficiency of the DMA device. If the transfer descriptor in the descriptor register is linked to another channel, the method flow moves to block 402 and the DMA device arbitrates the pending transfer requests.

Returning to decision block 408, if the DMA device determines that the major loop is complete, the method flow moves to block 410 and the DMA device determines if a scatter-gather operation is enabled. The DMA device can make this determination by consulting a field of the transfer descriptor in the descriptor register. If the scatter-gather operation is not enabled, the method flow moves to block 412 and the address and counter fields of the transfer descriptor are updated. The method flow then moves to block 416 to determine if the transfer descriptor is linked to the same channel.

Returning to decision block 410, if the scatter-gather operation is enabled, the method flow moves to block 414 and the DMA device retrieves a new transfer descriptor for the descriptor register. The new transfer descriptor may be retrieved from memory or any other location. Thus, at the conclusion of a major loop, the DMA device is able to update the transfer descriptor for a particular channel from any location through the scatter-gather operation. This allows the DMA device to implement transfer operations flexibly. After the new transfer descriptor has been received, the method flow moves to block 416 and the DMA device determines if the new transfer descriptor is linked to the same channel as the previously executed descriptor. If so, the method flow returns to block 406 and the new descriptor is executed without arbitration. If not, the method flow returns to block 402 so that the DMA can arbitrate the pending transfer requests.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the present disclosure is not intended to be limited to the specific form set forth herein, but on the contrary, it is intended to cover such alternatives, modifications, and equivalents, as can be reasonably included within the spirit and scope of the disclosure. It will further be appreciated that, although some circuit elements are depicted as connected to other circuit elements, the illustrated elements may also be coupled via additional circuit elements, such as resistors, capacitors, transistors, logic elements, and the like.

What is claimed is:

1. A method, comprising:
executing during a first time interval a first transfer request at a direct memory access (DMA) device, the first transfer request associated with a first channel of the DMA device;
determining at the DMA device a channel associated with a second transfer request;
arbitrating the second transfer request during a second time interval in response to determining that the second transfer request is associated with a second channel of the DMA device; and
executing the second transfer request during the second time interval in response to determining that the second transfer request is associated with the first channel of the DMA device.

2. The method of claim 1, wherein a descriptor associated with the second transfer request is accessed during the first time interval.

3. The method of claim 1, wherein determining the channel associated with the second transfer request further comprises determining the channel associated with the second transfer request based on a descriptor associated with the first transfer request.

4. The method of claim 1, further comprising:
determining a channel associated with a third transfer request;
after executing the second transfer request during the second time interval, arbitrating the third transfer request during a third time interval in response to determining that the third transfer request is associated with the second channel of the DMA device; and
after executing the second transfer request during the second time interval, executing the third transfer request during the third time interval in response to determining that the third transfer request is associated with the first channel of the DMA device.

5. The method of claim 4, wherein determining a channel associated with the third transfer request further comprises determining the channel based on a descriptor associated with the second transfer request.

6. The method of claim 1, wherein executing the second transfer request further comprises executing the second transfer request in response to determining that a channel link mode associated with the DMA device is enabled.

7. The method of claim 6, wherein arbitrating the second transfer request further comprises arbitrating the second transfer request in response to determining that the channel link mode is disabled.

8. The method of claim 1, wherein determining a channel associated with the second transfer request further comprises determining a channel associated with the second transfer request in response to determining that a channel link mode associated with the first channel is enabled.

9. A method, comprising:
determining at a DMA device a priority of a first transfer request based on an arbitration process;
executing the first transfer request; and
atomically executing a second transfer request with respect to the arbitration process in response to determining that the second transfer request is associated with the first channel.

10. The method of claim 9, further comprising determining a priority of the second transfer request based on the arbitration process in response to determining that the second transfer request is associated with a second channel of the DMA device.

11. The method of claim 9, further comprising determining a channel associated with the second transfer request at the DMA device based on a descriptor associated with the first transfer request.

12. The method of claim 9, further comprising:
after atomically executing the second transfer request, atomically executing a third transfer request with respect to the arbitration process in response to determining that the third transfer request is associated with the first channel.

13. The method of claim 12, further comprising
determining a channel associated with the third transfer request based on a descriptor associated with the second transfer request.

14. The method of claim 9, wherein atomically executing the second transfer request comprises determining the channel when a channel link mode associated with the DMA device is enabled.

15. The method of claim 14, further comprising determining a priority of the second transfer request based on the arbitration process when a channel link mode associated with the DMA device is disabled.

16. The method of claim 9, wherein atomically executing the second transfer request comprises atomically executing the second transfer request in response to determining that a channel link mode associated with the first channel is enabled.

17. A device, comprising:
a transfer descriptor register;
an arbitration module comprising an enable input and an output, the arbitration module to determine a priority level for transfer requests in response to assertion of a signal at the enable input, and to indicate a selected channel at the output, the selected channel associated with a first prioritized transfer request;
a first channel module comprising an input coupled to the output of the arbitration module, an output coupled to the transfer descriptor register, and an enable output, the channel startup module to store transfer descriptor information for the selected channel at the transfer descriptor register and to assert a signal at the enable output in response to storing the transfer descriptor information;
an execution module comprising an enable input coupled to the enable output of the channel startup module, the execution module to transfer information based on the transfer descriptor information at the transfer descriptor register in response to assertion of a signal at the enable input; and
a second channel module comprising a first enable output coupled to the enable input of the arbitration module and a second enable output coupled to the enable input of the execution module, wherein the channel shutdown module asserts a first signal at the second enable output in response to linking information at the transfer descriptor register indicating a pending transfer request is associated with the selected channel.

18. The device of claim 17, wherein the second channel module asserts a signal at the first enable output in response to linking information at the transfer descriptor register indicating a pending transfer request is associated with a different channel than the selected channel.

19. The device of claim 17, wherein the execution module includes an output coupled to the transfer descriptor register, and wherein the execution module modifies the transfer information at the transfer descriptor register after transferring information.

20. The device of claim 19, wherein the execution module modifies address information stored at the transfer descriptor register.
